(19) United States
(12) Patent Application Publication
(10) Pub. No.: US 2020/0115266 A1
(43) Pub. Date: Apr. 16, 2020

(54) Ultraviolet-Resistant Quartz Glass and Method of Producing the Same

(71) Applicant: TOSOH SGM CORPORATION, Yamaguchi (JP)

(72) Inventor: Hideharu Horikoshi, Yamaguchi (JP)

(73) Assignee: TOSOH SGM CORPORATION, Yamaguchi (JP)

(21) Appl. No.: 16/608,044

(22) PCT Filed: Apr. 11, 2018
(86) PCT No.: PCT/JP2018/015233

§ 371 Date: Oct. 24, 2019

(30) Foreign Application Priority Data
Apr. 26, 2017 (JP) 2017-086764
Jan. 24, 2018 (JP) 2018-009919

(51) Int. Cl. C03B 20/00; H01S 3/16; H01S 3/02; C03C 3/06; C03C 4/00

(52) U.S. Cl. CPC C03B 20/00; H01S 3/1643; H01S 3/025; C03C 2203/10; C03C 4/0071; C03C 2204/00; C03C 2201/02; C03C 3/06

(57) ABSTRACT

The present invention pertains to: a method for manufacturing an ultraviolet-resistant quartz glass, said method including melting a synthetic silica powder; and a method for manufacturing an ultraviolet-resistant quartz glass, said method including performing arc plasma melting of a silica powder. Provided is an ultraviolet-resistant quartz glass having an ultraviolet-resistance of 2500 seconds, wherein, taking the initial transmittance during irradiation of a quadruple higher harmonic (266 nm) of a YAG laser (irradiation performed at a YAG laser output of 180 mW, pulse width of 20 nsec, and frequency of 80 kHz) at an optical path length of 30 mm to be 100%, the irradiation period until the transmittance falls to 3% is defined as resistance to ultraviolet rays (referred to as ultraviolet-resistance). Also provided is an optical member for YAG-laser higher harmonics, said optical member comprising this quartz glass.

### TECHNICAL FIELD

The present invention relates to an ultraviolet-resistant quartz glass and a method of producing the same. In addition, the present invention relates to an optical member for harmonics of a YAG laser.

Priority is claimed on Japanese Patent Application No. 2017-86764, filed Apr. 26, 2017, and Japanese Patent Application No. 2018-009919, filed Jan. 24, 2018, the content of which is incorporated herein by reference.

### BACKGROUND ART

In the related art, carbon dioxide gas lasers have mainly been used for laser processing for cutting and drilling metals, ceramics, and glass using a high output laser beam. With the refinement of processing, use of laser beams with a shorter wavelength has begun, and YAG laser harmonics have gained attention as a light source for an ultraviolet-laser processing machine. In YAG lasers, an oscillation fundamental wavelength is 1,064 nm, but the second harmonic (532 nm), the third harmonic (355 nm), the fourth harmonic (266 nm), and the like are wavelength-converted and used for processing. Currently, the second and third harmonics are mainstream. However, the fourth harmonic is also put into practical use due to processing efficiency and low processing degradation, and in the future, the wavelength will be shortened in the fifth harmonic.

Generally, a synthetic quartz glass is used for an optical member which is used for controlling light of a processing machine using higher-order harmonics subsequent to the second harmonic of a YAG laser and beam shaping. This is because the synthetic quartz glass has excellent durability with respect to damage and transmittance. However, at higher-order harmonic wavelengths, the durability is not sufficient even in the synthetic quartz glass. It has been found that problems occur if the synthetic quartz glass is used without change in an optical system for a YAG third harmonic laser or higher harmonic laser.

Regarding a method of producing an ultraviolet-resistant quartz glass, for example, a method in which a synthetic quartz glass with a low impurity concentration is produced and oxygen molecules in the glass are then removed (PTL 1), a method in which hydrogen molecules are doped and ultraviolet light is then emitted (PTL 2), a method in which fluorine is doped (PTL 3), and the like have been proposed.

[PTL 1] Japanese Patent Application Publication No. H04-097922
[PTL 2] Japanese Patent Application Publication No. H09-124337

### [PTL 3] Japanese Patent Application Publication No. 2004-217506

The entire content of PTL 1 to 3 is specifically incorporated herein by reference.

### SUMMARY OF INVENTION

### Technical Problem

In any of the methods, in a general method of producing a material, it is essential to add a new process, and the processes become complicated and costs increase. In addition, ultraviolet-resistance of the quartz glass is not sufficient.

The present invention provides an ultraviolet-resistant quartz glass having durability with respect to a harmonic laser which is more excellent than that of a synthetic quartz glass optical material described in PTL 3 and a method of producing the same. In addition, the present invention provides an optical member for harmonics of a YAG laser.

### Solution to Problem

The inventors found that a quartz glass obtained using a synthetic silica powder as a raw material and melting it is a quartz glass having excellent ultraviolet-resistance, and particularly, it has high durability with respect to a fourth harmonic (266 nm) of a YAG laser, and thus completed a first aspect of the present invention.

In addition, the inventors found that a quartz glass obtained using a silica powder as a raw material and arc plasma melting it is a quartz glass having excellent ultraviolet-resistance, and particularly, it has high durability with respect to a fourth harmonic (266 nm) of a YAG laser, and thus completed a second aspect of the present invention.

The present invention is as follows.

[1] A method of producing an ultraviolet-resistant quartz glass or silica glass, comprising melting a synthetic silica powder prepared by a sol-gel method using an alkoxysilane as a raw material, a synthetic silica powder obtained by hydrolyzing a silicon halide or a synthetic silica powder obtained from fumed silica (a first aspect).

[2] The production method according to [1], wherein the melting is oxyhydrogen burner melting, arc plasma melting or electric furnace melting.

[3] The production method according to [1] or [2], wherein the synthetic silica powder is amorphous.

[4] A method of producing an ultraviolet-resistant quartz glass comprising arc plasma melting of a silica powder (a second aspect).

[5] The production method according to [4], wherein the silica powder is a synthetic silica powder or a natural quartz powder.

[6] The production method according to any one of [1] to [5], wherein the OH group concentration of the quartz glass is 500 ppm or less.

[7] The production method according to any one of [1] to [5], wherein the OH group concentration of the quartz glass is less than 100 ppm.

[8] The production method according to any one of [1] to [7], wherein the quartz glass has resistance with respect to harmonics of a YAG laser.

[9] The production method according to [8], wherein the harmonic of the YAG laser is a third harmonic, a fourth harmonic or a fifth harmonic.

[10] An ultraviolet-resistant quartz glass in which an emission time until the transmittance falls to 3% when the initial transmittance at a light path length of 30 mm is set as 100% and a YAG laser (emission conditions: a YAG laser output of 180 mW, a pulse width of 20 nsec, and a frequency of 80 kHz) using the fourth harmonic (266 nm) is emitted is designated as a resistance with respect to ultraviolet light, hereinafter referred to as ultraviolet-resistance, and the ultraviolet-resistance is 2,500 seconds or longer.

[11] The quartz glass according to [10], wherein the ultraviolet-resistance is 5,000 seconds or longer.

[12] The quartz glass according to [10] or [11], wherein the OH group concentration of the quartz glass is 500 ppm or less.

[13] The quartz glass according to [10] or [11], wherein the OH group concentration of the quartz glass is less than 100 ppm.

[14] The quartz glass according to any one of [10] to [13], wherein the quartz glass contains substantially no fluorine.

[15] An optical member for harmonics of a YAG laser, consisting of the quartz glass according to any one of [10] to [14].

[16] The optical member for harmonics of a YAG laser according to [15], wherein the harmonic of the YAG laser is a third harmonic, a fourth harmonic or a fifth harmonic.

### Advantageous Effects of Invention

According to the present invention, it is possible to provide a quartz glass having excellent ultraviolet-resistance. In particular, the quartz glass of the present invention has high durability against the fourth harmonic (266 nm) of a YAG laser. In addition, the quartz glass of the present invention exhibits high durability against the fourth harmonic (266 nm) of the YAG laser with different frequencies.

### DESCRIPTION OF EMBODIMENTS

<Method of Producing an Ultraviolet-Resistant Quartz Glass>

A first aspect of the present invention relates to a method of producing an ultraviolet-resistant quartz glass comprising melting a synthetic silica powder obtained by a specific production method.

A second aspect of the present invention relates to a method of producing an ultraviolet-resistant quartz glass comprising arc plasma melting of a silica powder.

The synthetic silica powder used in the first aspect of the present invention is a silica powder with a low impurity concentration, and for example, the concentration of alkali metals such as lithium, sodium and potassium, alkaline earth metals such as magnesium and calcium, and metals such as aluminum, iron, and copper is low, and the concentration of each metal is preferably less than 0.1 ppm, more preferably less than 0.05 ppm, and most preferably less than 0.01 ppm. Most preferably, the concentration is substantially 0 ppm, and in practice, the lower limit is larger than 0 ppm. In addition, in the synthetic silica powder, the OH group concentration is preferably low, and for example, an OH group concentration of less than 100 ppm, and preferably less than 50 ppm, is preferable in order to obtain a quartz glass with a low OH group concentration. A lower OH group concentration is preferable, and most preferably, the OH group concentration is substantially 0 ppm, and in practice, the lower limit is larger than 0 ppm. In addition, the synthetic silica powder is amorphous.

The synthetic silica powder is (i) a synthetic silica powder obtained by preparation according to a sol-gel method using an alkoxysilane as a raw material, (ii) a synthetic silica powder obtained by hydrolyzing a silicon halide, or (iii) fumed silica obtained by flame hydrolysis of a silicon compound. (i) In the sol-gel method using an alkoxysilane as a raw material, a synthetic silica powder is obtained by preparing a gel in a solution from an alkoxysilane, drying it and sintering it into a glass and a powder form. For example, the method described in Japanese Patent Application Publication No. S62-176928, or Japanese Patent Application Publication No. H03-275527 can be referred to. (ii) The method of hydrolyzing a silicon halide is, for example, a method of hydrolyzing silicon tetrachloride and then drying it and forming it into a powder. For example, a synthetic silica powder is obtained with reference to the method described in Japanese Examined Patent Publication No. H04-75848. (iii) Fumed silica is obtained due to a gas phase reaction such as flame hydrolysis of a silicon compound. For example, methods described in Japanese Patent No. 4548625 and Japanese Patent Application Publication No. 2001-220157 can be referred to.

In order to melt synthetic silica powder, for example, oxyhydrogen burner melting, arc plasma melting or electric furnace melting can be performed. Methods of melting a synthetic silica powder are broadly classified into two types including melting by flame and melting by electricity. Oxyhydrogen burner melting belongs to melting by flame. A synthetic silica powder raw material is supplied and melted in an oxyhydrogen flame. Arc plasma melting and electric furnace melting (using a crucible) are melting by electricity. Arc plasma melting is melting by electricity using arc discharging generated by applying a voltage between electrodes. Electric furnace melting (using a crucible) is, for example, a method of heating and melting a synthetic silica powder raw material in a carbon mold in an electric heater. The melting by electricity is preferable to melting by flame because the OH group concentration in the obtained quartz glass is low.

Oxyhydrogen burner melting used in the production method according to the first aspect of the present invention is preferably, for example, the method described in Japanese Patent Application Publication No. 2006-8452, because a quartz glass with a reduced impurity concentration can be obtained. Examples of arc plasma melting include the method described in Japanese Patent Application Publication No. H04-325425. For electric furnace melting (using a crucible), an existing method can be used without change.

Silica powder used in the production method according to the second aspect of the present invention is not particularly limited, and is preferably either synthetic silica powder or natural quartz powder because it has a low impurity concentration. The synthetic silica powder is the same as that of the first aspect of the present invention. Natural quartz powder is prepared by pulverizing natural quartz. The natural quartz powder has different types and concentrations of impurities depending on the quartz that is used as a raw material. In consideration of a raw material for a quartz glass with high ultraviolet-resistance, a low impurity concentration is preferable, and particularly, the concentration of metal impurities (for example, sodium, calcium, or iron) which affect ultraviolet-resistance is preferably 1 ppm or less, and more preferably 0.1 ppm or less for each element. However, since aluminum is present at a site of silicon in the framework structure of natural quartz in place of silicon, it is difficult to reduce it to a concentration lower than that of gemstone, and aluminum is generally contained in about 10 ppm. However, it is known that aluminum present in a framework structure does not significantly affect ultraviolet-resistance.

Arc plasma melting used in the production method according to the second aspect of the present invention is, as described above, melting by electricity using arc discharging generated by applying a voltage between electrodes, and in the present invention, for example, an existing method described in Japanese Patent Application Publication No. H04-325425 can be used.

The OH group concentration of the quartz glass obtained by the production method according to the first aspect and the second aspect of the present invention is preferably, for example, 500 ppm or less in order to obtain high ultraviolet-resistance, and more preferably 100 ppm or less, and most preferably less than 100 ppm. A lower OH group concentration is preferable, and most preferably the OH group concentration is substantially 0 ppm, and in practice, the lower limit is larger than 0 ppm.

The quartz glass obtained by the production method according to the first aspect and the second aspect of the present invention has resistance with respect to harmonics of a YAG laser. The harmonic of the YAG laser is a third harmonic, a fourth harmonic or a fifth harmonic.

<Ultraviolet-Resistant Quartz Glass>

The present invention includes an ultraviolet-resistant quartz glass. The ultraviolet-resistant quartz glass of the present invention is an ultraviolet-resistant quartz glass having an “ultraviolet-resistance” of 2,500 seconds or longer. The “ultraviolet-resistance” is defined as an emission time until the transmittance falls to 3% when the initial transmittance at a light path length of 30 mm is set as 100% and a YAG laser (emission conditions: a YAG laser output of 180 mW, a pulse width of 20 nsec, and a frequency of 80 kHz) using the fourth harmonic (266 nm) is emitted.

The ultraviolet-resistant quartz glass of the present invention is produced by the production method (the first aspect or the second aspect) of the present invention. The ultraviolet-resistance of the ultraviolet-resistant quartz glass of the present invention is preferably 5,000 seconds or longer and more preferably 6,000 seconds or longer. A higher ultraviolet-resistance is more preferable, and the practical upper limit is 15,000 seconds and preferably 20,000 seconds, but this is not intended to limit the present invention.

The OH group concentration of the ultraviolet-resistant quartz glass of the present invention is preferably 500 ppm or less in consideration of ultraviolet-resistance, and the OH group concentration is more preferably 300 ppm or less, still more preferably 100 ppm or less, still more preferably less than 100 ppm, still more preferably 50 ppm or less, and most preferably 30 ppm or less. A lower OH group concentration is more preferable, and most preferably, the OH group concentration is substantially 0 ppm, and the practical lower limit is larger than 0 ppm.

The ultraviolet-resistant quartz glass of the present invention contains substantially no fluorine. As described above, in the production method according to the first aspect, the quartz glass of the present invention is prepared by melting a synthetic silica powder with a low impurity concentration so that contaminants mixed in during melting can be reduced and the impurity concentration can be reduced. In addition, no fluorine is added as an additive. In the production method according to the second aspect, a silica powder containing no fluorine is used as a raw material, and there is no process of adding fluorine to a quartz glass in a production process, and thus the quartz glass of the present invention contains substantially no fluorine.

<Optical Member>

The present invention includes an optical member for harmonics of a YAG laser, which is made of the quartz glass of the present invention. The optical member is a filter, a prism, a lens or the like. Examples of harmonics of a YAG laser include a third harmonic, a fourth harmonic and a fifth harmonic. The optical member of the present invention has excellent durability for harmonics of a YAG laser.

### EXAMPLES

The present invention will be described below in more detail with reference to examples. However, the examples are only examples of the present invention, and the present invention is not limited to the examples.

### Examples 1 to 4 and Comparative Examples 1 to 4

Samples 4 to 6 and 8 were prepared as Examples 1 to 4, and Samples 1 to 3 and 7 were prepared as Comparative Examples 1 to 4.

Sample 1: Silicon tetrachloride was used as a raw material, and a quartz glass ingot was produced by a direct method. The raw material was supplied from a central tube of a quartz glass burner, H₂ gas and O₂ gas were supplied from an outer tube of the burner, silica fine particles were synthesized due to a dehydration condensation reaction, and deposited on a target, and at the same time, formed into a transparent glass to obtain an ingot. The ingot was processed into a 30 mm cube and used as an evaluation sample.

Sample 2: A sample produced under the same conditions as in Sample 1 except that silicon tetrafluoride was used as a raw material was used as Sample 2.

Sample 3: Silicon tetrachloride was used as a raw material and a quartz glass ingot was produced by a soot method. The raw material was supplied from a central tube of a quartz glass burner, and H₂ gas and O₂ gas were supplied from an outer tube of the burner to synthesize a soot product. The soot product was heated in a 1 vol % silicon tetrafluoride gas (the remainder was He gas) atmosphere at 1,200° C. for 5 hours. Then, a heat treatment was performed in a 100% He gas atmosphere at 1,500° C. for 5 hours to obtain a transparent ingot. The ingot was processed into a 30 mm cube and used as an evaluation sample.

Sample 4: A synthetic silica powder was used as a raw material, melted in an oxyhydrogen burner, and deposited in a container composed of refractory bricks and a quartz glass ingot was produced. The ingot was processed into a 30 mm cube and used as an evaluation sample.

Sample 5: A synthetic silica powder was used as a raw material, an arc plasma was generated between a cathode torch and an anode torch, a raw material powder was introduced into the plasma and melted and then deposited on a target, and a quartz glass ingot was produced. The ingot was processed into a 30 mm cube and used as an evaluation sample.

Sample 6: A synthetic silica powder was used as a raw material, a raw material powder was filled into a carbon mold, and the mold was then set in an electric furnace, a raw material powder was melted in a nitrogen atmosphere at 1,800° C. in an electric furnace, and a quartz glass ingot was produced. The ingot was processed into a 30 mm cube and used as an evaluation sample.

Sample 7: A sample produced under the same conditions as in Sample 4 except that a natural quartz powder was used as a raw material was used as Sample 7.

Sample 8: A sample produced under the same conditions as in Sample 5 except that a natural quartz powder was used as a raw material was used as Sample 8.

The synthetic silica powders used in Samples 4 to 6 were MKC powders (commercially available from Nihon Kasei CO., LTD.) produced by a sol-gel method using an alkoxysilane (tetramethoxysilane Si(OC₂H₅)₄ or the like) as a raw material. The impurity analysis results of MKC powder are shown in Table 1. The impurity analysis result of Sample 4 and the impurity analysis result of natural quartz powder are also shown in Table 1.

TABLE 1
Impurity concentration (ppm)

| | Element | | | | | | | |
|---|---|---|---|---|---|---|---|---|
| | Li | Na | Mg | Al | K | Ca | Fe | Cu |
| Natural powder | 0.2 | 0.2 | 0.1 | 8 | 0.1 | 0.7 | 0.2 | <0.01 |
| Synthetic | <0.01 | <0.01 | <0.01 | 0.01 | <0.01 | <0.01 | 0.03 | <0.01 |
| powder | | | | | | | | |
| Sample 4 | <0.01 | 0.3 | <0.01 | 0.7 | <0.01 | <0.01 | 0.05 | <0.01 |

Ultraviolet-Resistance Test Method

The ultraviolet-resistance of the sample quartz glass was requested toLaser lab Inc. and evaluated according to change in the transmittance when a YAG laser (emission conditions: a YAG laser output of 180 mW, a pulse width of 20 nsec, and a frequency of 80 kHz) using the fourth harmonic (266 nm) was emitted. The resistance was evaluated as an emission time until the transmittance fell to 3% when the initial transmittance at a light path length of 30 mm was set as 100%. The results are shown in Table 2.

TABLE 2

| | | | OH group | | |
|---|---|---|---|---|---|
| | | | concentration | Resistance | Relative |
| Sample | Raw material | Production method | ppm | sec | evaluation |
| 1 (Comparative Example 1) | Silicon tetrachloride | Oxyhydrogen burner melt | 1,040 | 750 | 1.0 |
| 2 (Comparative Example 2) | Silicon tetrafluoride | Oxyhydrogen burner melt | 820 | 850 | 1.1 |
| 3 (Comparative Example 3) | Silicon tetrachloride | Soot synthesis + F doped | 270 | 1,350 | 1.8 |
| 4 (Example 1) | Synthetic silica powder | Oxyhydrogen burner melt | 230 | 2,700 | 3.6 |
| 5 (Example 2) | Synthetic silica powder | Plasma melt | 15 | 7,100 | 9.5 |
| 6 (Example 3) | Synthetic silica powder | Electric melt | 8 | 3,050 | 4.1 |
| 7 (Comparative Example 4) | Natural quartz powder | Oxyhydrogen burner melt | 210 | 2,200 | 2.9 |
| 8 (Example 4) | Natural quartz powder | Plasma melt | 20 | 5,100 | 6.8 |

Comparing Examples 1 to 3 and Comparative Examples 2 and 3, it was found that an ultraviolet-resistant quartz glass could be produced by melting a synthetic silica powder containing no fluorine. In addition, comparing Example 2 and Example 1 and comparing Example 4 and Comparative Example 4, it was found that, when silica powder containing no fluorine was used as a raw material, if the raw material was the same, it was possible to produce a quartz glass having better ultraviolet-resistance in plasma melting as compared with oxyhydrogen burner melting.

Frequency Dependence

For Examples 1, 2, and 4 and Comparative Examples 1 and 4, the frequency dependence was evaluated by changing the frequency of the laser. The results are shown in Table 3.

Examples 2 and 4 exhibited high resistance regardless of the frequency, and Example 1 also exhibited relatively high resistance.

TABLE 3

| | Frequency (kHz) | | | | | |
|---|---|---|---|---|---|---|
| | 30 | | 80 | | 120 | |
| | Resistance | Relative | Resistance | Relative | Resistance | Relative |
| Sample | (sec) | evaluation | (sec) | evaluation | (sec) | evaluation |
| 1 (Comparative | 740 | 1.0 | 750 | 1.0 | 1,650 | 1.0 |
| Example 1) | | | | | | |
| 4 (Example 1) | 2,150 | 2.9 | 2,700 | 3.6 | 5,600 | 3.4 |
| 5 (Example 2) | 4,000 | 5.4 | 7,100 | 9.5 | 16,900 | 10.2 |
| 7 (Comparative | 1,900 | 2.6 | 2,200 | 2.9 | 4,850 | 2.9 |
| Example 4) | | | | | | |
| 8 (Example 4) | 3,600 | 4.9 | 5,100 | 6.8 | 12,200 | 7.4 |

### INDUSTRIAL APPLICABILITY

The present invention is beneficial in fields related to a quartz glass having excellent ultraviolet-resistance.

1-3. (canceled)

4. A method of producing an ultraviolet-resistant quartz glass used for a fourth harmonic or a fifth harmonic of an YAG laser, comprising
arc plasma melting of a silica powder to obtain the quartz glass having an ultraviolet-resistance of 5,000 seconds or longer,
wherein the ultraviolet-resistance is an emission time until the transmittance falls to 3% when the initial transmittance at a light path length of 30 mm is set as 100% and a YAG laser is emitted using the four harmonic,
the YAG laser emission conditions are a YAG laser output of 180 mW, a pulse width of 20 nsec, and a frequency of 80 kHz, and
the fourth harmonic has a wavelength of 266 nm.

5. The production method according to claim 4, wherein the silica powder is a synthetic silica powder or a natural quartz powder.

6. (canceled)

7. The production method according to claim 4, wherein the —OH group concentration of the quartz glass is less than 100 ppm.

8-9. (canceled)

10. An optical member for a fourth harmonic or a fifth harmonic of a YAG laser, consisting of an ultraviolet-resistant quartz glass having an ultraviolet-resistance of 5,000 seconds or longer,
wherein the ultraviolet-resistance is emission time until the transmittance falls to 3% when the initial transmittance at a light path length of 30 mm is set as 100% and a YAG laser is emitted using the fourth harmonic,
the YAG laser emission conditions are a YAG laser output of 180 mW, a pulse width of 20 nsec, and a frequency of 80 kHz, and
the fourth harmonic has a wavelength of 266 nm.

11. The optical member according to claim 10, wherein the ultraviolet-resistance is 6,000 seconds or longer.

12. (canceled)

13. The optical member according to claim 10, wherein the —OH group concentration of the quartz glass is less than 100 ppm.

14. The optical member according to claim 10, wherein the quartz glass contains substantially no fluorine.

15-16. (canceled)

17. The production method according to claim 5, wherein the —OH group concentration of the quartz glass is less than 100 ppm.

18. The optical member according to claim 11, wherein the —OH group concentration of the quartz glass is less than 100 ppm.

19. The optical member according to claim 11, wherein the quartz glass contains substantially no fluorine.

20. The optical member according to claim 13, wherein the quartz glass contains substantially no fluorine.
